(19) United States
(12) Patent Application Publication
(10) Pub. No.: US 2011/0280786 A1
(43) Pub. Date: Nov. 17, 2011

(54) SILICON MANUFACTURING METHOD

(75) Inventors: Kunio Saegusa, Ibaraki (JP); Kentaro Shinoda, Ibaraki (JP); Hideyuki Murakami, Ibaraki (JP)

(73) Assignees: NATIONAL INSTITUTE FOR MATERIALS SCIENCE, Tsukuba-shi, Ibaraki (JP); SUMITOMO CHEMICAL COMPANY, LIMITED, Tokyo (JP)

(21) Appl. No.: 13/133,748

(22) PCT Filed: Dec. 10, 2009
(86) PCT No.: PCT/JP2009/070687

§ 371 Date: Jul. 28, 2011

(30) Foreign Application Priority Data
Dec. 10, 2008 (JP) 2008-314966

(51) Int. Cl. C01B 33/023

(52) U.S. Cl. 423/350

(57) ABSTRACT

A method for producing silicon, the method comprising a heating step of heating a metal powder Mₚ₁ made of at least one member selected from the group consisting of Mg, Ca and Al in a plasma P; and a reducing step of reducing a halogenated silane G1 by the metal powder Mₚ₂ heated in the plasma P to obtain silicon.

### TECHNICAL FIELD

The present invention relates to a method for producing silicon.

### BACKGROUND ART

As a method for producing semiconductor grade silicon, Siemens method, in which trichlorosilane is reacted with hydrogen at a high temperature, is mainly adopted. Although very high purity silicon can be produced by the method, the cost is high and it is said that further cost reduction is difficult.

Since environmental problems have come to the forefront, a solar cell has attracted interest as a clean energy source and the demand thereof has been rapidly increasing mainly for residential use. Since a silicon based solar cell is superior in reliability and conversion efficiency, it occupies about 80% of the solar photovoltaic power generation. Silicon for solar cell is made of, as the main source material, an off-specification product of semiconductor grade silicon. Consequently, an inexpensive source material silicon has been desired to be secured in order to make the power generation cost further reduce.

As a method for producing silicon alternative to the Siemens method, is disclosed, e.g., in the following Patent Literatures 1 to 3, a method for producing silicon by reducing a halogenated silane by a reducing agent (for example a molten metal).

Further, in the following Patent Literatures 4 and 5 and Non Patent Literature 1 is disclosed a technology concerning a reduction reaction of a halide with a reducing metal heated in a plasma. Especially in the following Patent Literature 5 is disclosed a method for obtaining silicon by reacting a reducing metal Zn with tetrachlorosilane. In the following Non Patent Literature 1 is disclosed a method for obtaining silicon by reacting a reducing metal Na with tetrachlorosilane.

### CITATION LIST

### Patent Literature

Patent Literature 1: JP59-182221A

Patent Literature 2: JP2-64006A

Patent Literature 3: JP2007-284259A

Patent Literature 4: JP58-110626A

Patent Literature 5: CN 1962434A

### Non Patent Literature

Non Patent Literature 1: Herberlein, J., “The reduction of tetrachlorosilane by sodium at high temperatures in a laboratory scale experiment”, Int. Symp. Plasma Chemistry, 4th, Vol. 2, 716-22 (1979).

### SUMMARY OF INVENTION

### Technical Problem

The present inventors have found that the methods for producing silicon described in the Patent Literature 5 and Non Patent Literature 1 have problems in productivity and production cost as shown below.

In a method of reducing tetrachlorosilane by Zn heated in a plasma as shown in the above-described Patent Literature 5, Zn tends to vaporize and diffuse when Zn is heated in a plasma. When vaporized Zn reacts with tetrachlorosilane, the produced silicon grows into the four of a whisker through the vapor phase, which requires a long time for the produced silicon to grow into a silicon particle whose size is applicable to a solar cell. In case the vaporized Zn diffuses excessively in the reaction field, the concentration of Zn in the reaction field decreases and the contact frequency between Zn and tetrachlorosilane decreases, and thereby the reaction velocity and the reaction rate tend to lower. For the above-described reasons, the method according to the Patent Literature 5 cannot improve adequately the productivity of silicon.

In the method of reducing tetrachlorosilane by Na heated in a plasma as shown in the Non Patent Literature 1, since Na is a monovalent metal, 4 moles of Na is required to reduce 1 mole of tetrachlorosilane. Further, the reducing agent Na itself is expensive, whose cost exceeds the market price of silicon. As describes above, the method described in the Non Patent Literature 1 requires a large amount of expensive Na and an enormous production cost, and therefore it is not an industrially practicable technology and has not been industrialized.

To solve the above-described problem, the present invention provides a method for producing silicon that can improve the productivity of silicon and also reduce the production cost of silicon.

### Solution to Problem

To attain the above-described object, the method for producing silicon according to the present invention comprises a heating step of heating a metal powder made of at least one member selected from the group consisting of Mg, Ca and Al in a plasma and/or a plasma jet; and a reducing step of reducing a halogenated silane by the metal powder heated in the plasma and/or the plasma jet to obtain silicon.

According to the present invention is used as a reducing agent for a halogenated silane a metal powder made of at least any one of Mg, Ca and Al having a boiling point higher than Zn. Therefore, in case the metal powder is heated in a plasma and/or a plasma jet, different from the case of Zn, the metal powder does not vaporize easily and exists as a solid or a liquid droplet. In case the metal powder in a solid form or the metal powder turned into a liquid droplet form is reacted with a halogenated silane, the produced silicon grows through the solid phase or through the liquid phase. Consequently, according to the present invention the time required for the produced silicon to grow into a silicon particle having a size applicable to a solar cell can be shortened, compared to the case where the silicon produced by reduction with Zn grows through the vapor phase.

According to the present invention, the metal powder in a solid form or the metal powder turned into a liquid droplet form, different from vaporized Zn, does not diffuse excessively into the reaction field. Consequently, according to the present invention using the metal powder as a reducing agent, the concentration of a reducing agent in the reaction field can be higher than the case using Zn as a reducing agent, and the contact frequency between the reducing agent and a halogenated silane can be higher to improve the reaction velocity and the reaction rate of the reducing agent with the halogenated silane.

According to the present invention, since the metal powder, namely a powdery reducing agent, is heated in a plasma and/or a plasma jet, the reducing agent can be heated up and activated in a short period of time, and thereby the reaction velocity and the reaction rate of the reducing agent with a halogenated silane can be improved.

For these reasons, the productivity of silicon can be improved according to the present invention compared to the case using Zn as a reducing agent.

According to the present invention, since a metal powder made of at least one member of Mg, Ca and Al whose valency is higher than monovalent Na is used as a reducing agent for a halogenated silane, the amount by mole of a reducing agent (metal powder) required for reducing 1 mole of halogenated silane in the reduction reaction of a halogenated silane can be decreased compared to the case using Na. Consequently, according to the present invention, compared to the case using Na as a reducing agent, the amount of the reducing agent required for producing silicon can be decreased and the production cost of silicon can be reduced.

According to the present invention, it is preferable in the heating step to heat a mixture of a source gas of the plasma and/or a source gas of the plasma jet and the metal powder in the plasma and/or the plasma jet. Since the source gas of the plasma and/or the source gas of the plasma jet can be utilized as a carrier gas for the metal powder, the metal powder can be supplied easily and surely into the plasma and/or the plasma jet and also contamination of the metal powder during the transportation can be suppressed.

According to the present invention, it is preferable in the heating step to supply the metal powder into the plasma and/or the plasma jet and heat the metal powder in the plasma and/or the plasma jet, and in the reducing step to bring the metal powder heated in the plasma and/or the plasma jet into contact with the halogenated silane to reduce the halogenated silane to obtain silicon. According to the above, the reduction reaction of the halogenated silane can be progressed more easily.

According to the present invention, it is preferable in the heating step to heat the metal powder in the plasma and/or the plasma jet to liquefy the metal powder. In other words, according to the present invention, it is preferable to make the temperature of the metal powder be not lower than the melting point of the metal powder and lower than the boiling point of the metal powder by heating the metal powder in the plasma and/or the plasma jet. By this means, while suppressing vaporization of the metal powder, the activity of the metal powder as a reducing agent can be enhanced and the reaction velocity and the reaction rate of the metal powder with the halogenated silane can be further improved.

According to the present invention, it is preferable in the heating step to supply the halogenated silane into the plasma and/or the plasma jet. By this means, the heated metal powder and the halogenated silane can be brought into contact with each other more surely and reacted with each other in the high temperature reaction field, and thereby the reaction velocity and the reaction rate of the metal powder with the halogenated silane can be further improved.

According to the present invention, it is preferable that the source gas of the plasma and/or the source gas of the plasma jet be at least one member selected from the group consisting of H₂, He and Ar. By this means, a stable plasma and/or a stable plasma jet can be generated more easily.

According to the present invention, the metal powder is preferably made of Al, and the halogenated silane is preferably tetrachlorosilane. By this means, high purity silicon can be obtained more easily.

According to the present invention, the plasma is preferably a thermal plasma, and the plasma jet is preferably a thermal plasma jet.

The thermal plasma or the thermal plasma jet is a plasma or a plasma jet, which have a higher particle density of ions or neutral particles than a low-temperature plasma or a low-temperature plasma jet generated by glow discharge under a low pressure, etc. and have the temperature of ions or neutral particles approximately same as the electron temperature. Since the thermal plasma or the thermal plasma jet each have a higher energy density than the low-temperature plasma or the low-temperature plasma jet, the metal powder and the halogenated silane can be heated up to a high temperature surely and in a short period of time, and thereby the reaction velocity and the reaction rate of the metal powder with the halogenated silane can be further improved.

According to the present invention, the thermal plasma is preferably a direct-current arc plasma, and the thermal plasma jet is preferably a direct-current arc plasma jet. Since a high speed plasma jet (a direct-current arc plasma jet) can be generated using the direct-current arc plasma as the thermal plasma, heating of the metal powder and the reduction reaction of the halogenated silane can be conducted in a time period as short as about 1 sec or less (magnitude of msec).

### ADVANTAGEOUS EFFECTS OF INVENTION

According to the present invention, provided is a method for producing silicon, which can improve the productivity of silicon and reduce the production cost of silicon.

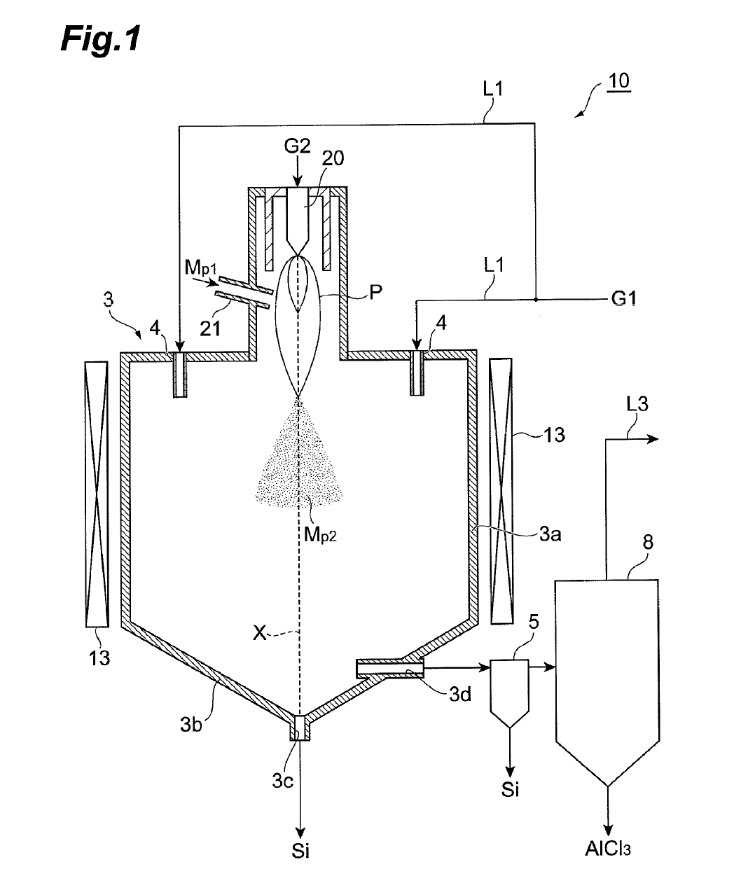

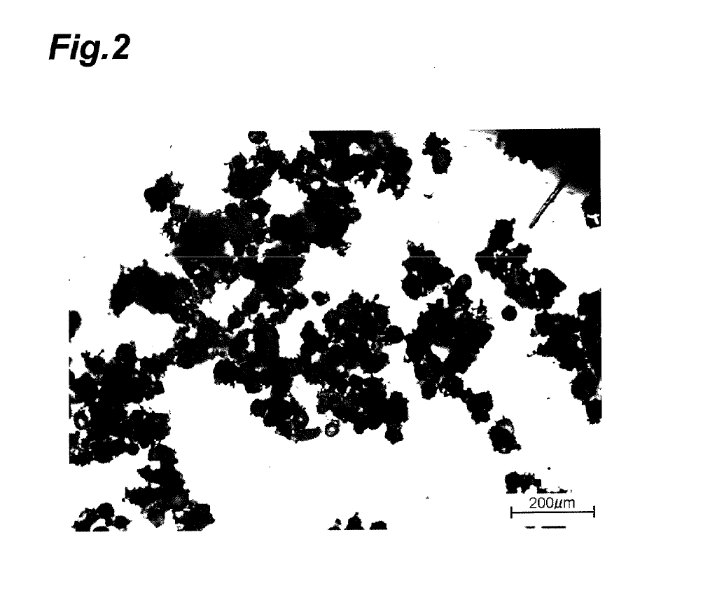

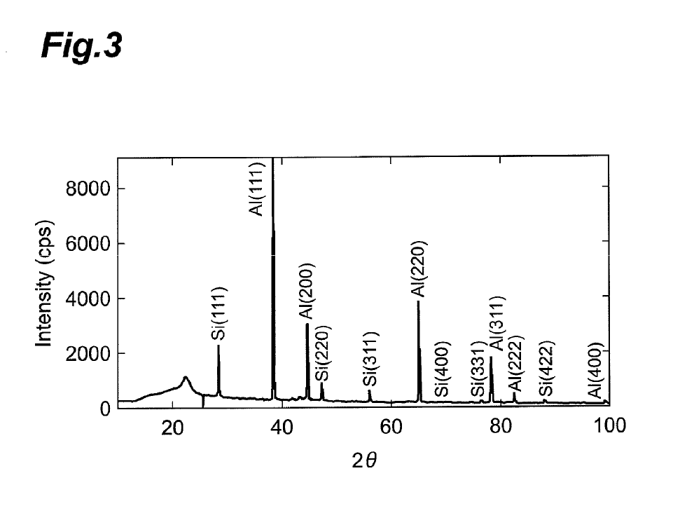

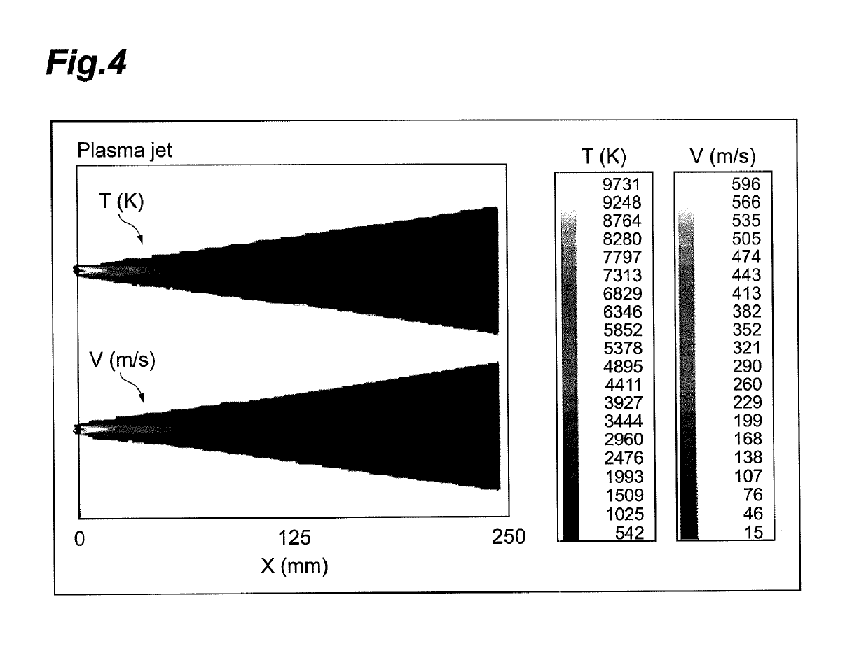

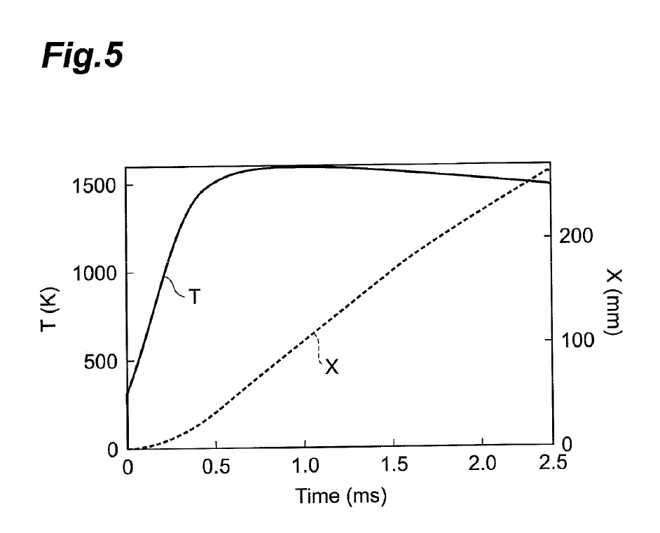

### BRIEF DESCRIPTION OF DRAWINGS

[FIG. 1] FIG. 1 is a schematic view showing a method for producing silicon and a production equipment according to an embodiment of the present invention.

[FIG. 2] FIG. 2 is a light micrograph of a powder of a product obtained in Example 1 of the present invention.

[FIG. 3] FIG. 3 is a powder X-ray diffractometry pattern of a powder of a product obtained in Example 1 of the present invention.

[FIG. 4] FIG. 4 is a diagram showing the distributions of the temperature T (in K) in a plasma jet and the gas linear velocity V (in m/s) of a plasma.

[FIG. 5] FIG. 5 is a diagram showing the changes over time of the temperature T (in K) and the flight distance X (in mm) of an Al particle supplied into a plasma jet.

### DESCRIPTION OF EMBODIMENTS

Referring to FIG. 1 production equipment 10 of silicon and a method for producing silicon using the production equipment 10 according to a preferable embodiment of the present invention will be described below in more detail. In the drawing, the same or equivalent parts are attached with the same signs, and duplicate descriptions are omitted. Positional relationship, such as top and bottom, and left and right is based on the positional relationship shown in the drawing, unless otherwise specified. Further, a dimensional ratio of the drawing is not limited to the ratio as illustrated.

The “plasma” in the present invention means a electrically neutral state of a material, in which freely moving positively and negatively charged particles coexist. As a plasma according to the present invention a thermal plasma, a mesoplasma or a low pressure plasma is preferable, more preferable is a thermal plasma or a mesoplasma, and most preferable is a thermal plasma.

The “plasma jet” in the present invention means a gas stream obtained by means of a plasma, in other words, a gas stream originated from a plasma.

Whether a state of a material (a plasma source material) is a plasma (ionization state) or a plasma jet (a gas stream originated from a plasma, namely a flow of a gas originated from a plasma) is determined by a type of a plasma source material, and the temperature thereof. For example, in an arc plasma, the state of a material changes continuously from a plasma to a plasma jet. At some location in an arc plasma atoms/molecules and ionized atomic nuclei/electrons may coexist, which may be referred to as coexistence of a plasma and a plasma jet.

Hereinafter a plasma and a plasma jet are referred to collectively as “plasma P” without specific discrimination.

As shown in FIG. 1, the production equipment 10 for silicon according to the present embodiment is provided with an approximately cylindrical reactor 3 extended vertically, a plasma generator 20, an aluminum powder supply pipe 21, through which a metal powder Mₚ₁ made of aluminum (hereinafter referred to as “aluminum powder”) is supplied into a plasma P generated by the plasma generator 20, and an SiCl₄ nozzle 4, through which a tetrachlorosilane gas G1 is supplied into the reactor 3. In this connection, FIG. 1 is a schematic cross-sectional view of the production equipment 10 taken along a longitudinal direction of the reactor 3.

A gas for generating a plasma G2 (a source gas of a plasma) is supplied through a gas entry hole (not illustrated) to the plasma generator 20. The container of the plasma generator 20 is constituted of a material which is hard to become a contamination source to the produced silicon. Examples of such a material include Ni based alloys, such as SUS 304, SUS 316, and Inconel 718.

It is preferable to coat the inside of the container of the plasma generator 20 with a silicon resin, a fluorine resin, or the like in order to prevent contamination of the produced silicon further surely.

The aluminum powder Mₚ₁ is supplied by an aluminum powder feeder (not illustrated) through the aluminum powder supply pipe 21 into the plasma P. The aluminum powder feeder is provided with a powder container storing inside the aluminum powder Mₚ₁, a gas inlet pipe introducing a carrier gas into the powder container, and a stirring device placed inside the powder container, which stirs and fluidizes the aluminum powder Mₚ₁.

The tetrachlorosilane gas G1 is supplied from a tetrachlorosilane feeder (not illustrated) through a supply pipe L1 to the SiCl₄ nozzle 4. The tetrachlorosilane feeder is provided with a tetrachlorosilane storage container, a vaporizer, which heat-evaporates the tetrachlorosilane in the storage container according to a required flow rate of the tetrachlorosilane and then optionally dilutes the tetrachlorosilane with an Ar gas, etc, and a flow rate regulator, which regulates the flow rate of the vaporized tetrachlorosilane and feeds it into the reactor 3.

The reactor 3 is provided with the cylindrical part 3a extended vertically and a silicon collector 3b situated beneath the cylindrical part 3a. The inside of the reactor 3 is isolated from the outside. In the reactor 3 is formed a reaction field where a reduction reaction expressed by the Formula (A) described below proceeds. Consequently, an ample space to conduct the reduction reaction is secured inside the reactor 3. The reactor 3 is constructed with a usual stainless steel, etc. By this means, the reactor 3 can be protected from corrosion by a chloride, etc. Further, by constructing the reactor 3 with a usual stainless steel, etc., the equipment cost for producing silicon can be suppressed to a low level.

On the upper part of the cylindrical part 3a are placed the plasma generator 20, the aluminum powder supply pipe 21 and the SiCl₄ nozzle 4. The plasma generator 20 is situated on the central axis X of the reactor 3 (the central axis of the cylindrical part 3a). Although the production equipment 10 in FIG. 1 is provided with two SiCl₄ nozzles 4, the number of the SiCl₄ nozzle 4 can be also one, or three or more. In case the production equipment 10 has a plurality of SiCl₄ nozzles 4, the plurality of SiCl₄ nozzles 4 should preferably be situated on a concentric cylinder with a center on the central axis X of the reactor, but may be also situated on a plurality of concentric cylinders with centers on the central axis X of the reactor. The plurality of SiCl₄ nozzles 4 should preferably be situated at regular intervals.

The method for producing silicon according to the present embodiment using the production equipment 10 includes a heating step, in which the aluminum powder Mₚ₁ is supplied into the plasma P, where the aluminum powder Mₚ₁ is heated; and a reducing step, in which the tetrachlorosilane gas G1 is brought into contact with the aluminum powder Mₚ₂ heated in the plasma P to conduct the reduction reaction represented as the following Formula (A) to obtain silicon particles.

3SiCl₄+4Al→3Si+4AlCl₃ (A)

Namely, according to the present embodiment, the aluminum powder Mₚ₂ heated in the plasma P is fed by the plasma P into the reactor 3 to react with the tetrachlorosilane gas G1 supplied in the reactor 3. The thus obtained silicon particles can be utilized suitably as a solar cell material.

In the heating step according to the present invention, the aluminum powder Mₚ₁ can be heated in a plasma, or heated in a plasma jet, or heated in an atmosphere where a plasma and a plasma jet coexist.

The diameter of the aluminum powder Mₚ₁ is preferably 100 μm or less, subject to a setting of the equipment and operation conditions, and more preferably 50 μm or less, and further preferably 30 μm or less. This can improve the feedability of the aluminum powder Mₚ₁ by a carrier gas into the plasma P. From the viewpoint of preventing evaporation of the aluminum powder Mₚ₁, the diameter of the aluminum powder Mₚ₁ is preferably 5 μm or more. In case a metal powder other than the aluminum powder Mₚ₁ is used as a reducing agent, the particle size of the metal powder can be adjusted according to its material.

In the heating step, it is preferable to supply a mixture of the aluminum powder Mₚ₁ and the source gas G2 of the plasma P into the plasma P through the aluminum powder supply pipe 21. Namely, by using the plasma source gas G2 as a carrier gas for the aluminum powder Mₚ₁, the aluminum powder Mₚ₁ can be easily and surely transported into the plasma P and the contamination of the aluminum powder Mₚ₁ during the transportation can be suppressed.

In the heating step, it is preferable to heat the aluminum powder Mₚ₁ in the plasma P to liquefy the aluminum powder Mₚ₁. Namely, it is preferable to adjust the temperature of the aluminum powder Mₚ₂ after heated in the plasma P to the melting point or higher and lower than boiling point. This can enhance the activity of the aluminum powder Mₚ₂ as a reducing agent, and thereby the reaction velocity and the reaction rate of the aluminum powder Mₚ₂ with the tetrachlorosilane gas G1 can be improved. By bringing the temperature of the aluminum powder Mₚ₂ to lower than the boiling point after heating, a gas phase reaction of the aluminum powder Mₚ₂ with the tetrachlorosilane gas G1 can be prevented. The temperature of the aluminum powder Mₚ₂ (molten droplet) after heating is determined mainly by parameters, such as the particle size of the aluminum powder Mₚ₁ before heating, the residence time of the aluminum powder Mₚ₁ in the plasma P, and the temperature of an area of the plasma P, where the aluminum powder Mₚ₁ passes.

Examples of a source gas G2 for the plasma P include H₂, He, Ar, and N₂, and at least one member selected from the group consisting of H₂, He and Ar is preferable. By adding a monoatomic molecule of Ar to the source gas G2, a plasma can be generated more easily, and by adding H₂ or He as the second gas in addition to Ar to the source gas G2, the plasma can be stabilized. In case the plasma needs high enthalpy, a diatomic molecule of N₂ can be used as the source gas G2. Specific examples of source gases G2 and combinations thereof include Ar, Ar—H₂, Ar—He, N₂, N₂—H₂, and Ar—He—H₂.

The central temperature of the plasma P is preferably 1000 to 30000° C. and more preferably 3000 to 30000° C. In case the temperature of the plasma P is too low, the aluminum powder Mₚ₁ cannot be heated sufficiently, and the effect of the present invention tends to be compromised. In case the temperature of the plasma P is too high, a part of the aluminum powder Mₚ₁ vaporizes off, and the effect of the present invention tends to be compromised.

The plasma P is preferably a thermal plasma and/or a thermal plasma jet. Since a thermal plasma and/or a thermal plasma jet has a higher energy density than a low-temperature plasma or a low-temperature plasma jet, the aluminum powder Mₚ₁ can be heated up to a high temperature surely and in a shorter period of time, and thereby the reaction velocity and the reaction rate of the aluminum powder Mₚ₂ after heating with the tetrachlorosilane gas G1 can be improved. The plasma P can be an intermediate range plasma (mesoplasma) or a mesoplasma jet, whose temperature are higher than a low-temperature plasma but lower than a thermal plasma. In this connection, a mesoplasma jet means a plasma jet originated from a mesoplasma.

Examples of a method for generating a thermal plasma include a direct-current arc method or a high frequency inductive coupling method. The direct-current arc method is characterized in that the generating mechanism of a thermal plasma is simple and the equipment is inexpensive, a trace amount of impurities originated from an electrode may contaminate silicon, and the available time for conducting the reduction reaction according to the Formula (A) (the period of time in which the reaction product of the reduction reaction according to the Formula (A) can exist in the vicinity of the plasma) is as short as about 1 sec or less (magnitude of msec) in order for the obtained thermal plasma jet to have a high speed.

Meanwhile, the high frequency inductive coupling method is characterized in that the equipment is expensive, possibility of contamination of impurities into silicon is small because of electrodeless discharge, and the available time for conducting the reduction reaction according to the Formula (A) is long because of low speed of the obtained thermal plasma jet.

In the case, such as solar cell silicon, where contamination with a small amount of impurities does not cause a serious problem, rather a large scale production and low production cost are required, the direct-current arc method is preferable. In the case of producing silicon where contamination with a small amount of impurities causes a problem and the production cost may be high, the high frequency inductive coupling method is preferable.

The “thermal plasma jet” described above means a plasma jet to be obtained originating from a thermal plasma, in other words a plasma jet obtained by means of a thermal plasma.

According to the present embodiment, the thermal plasma is preferably a direct-current arc plasma, and the thermal plasma jet is preferably a direct-current arc plasma jet. Since a direct-current arc plasma can generate a high speed direct-current arc plasma jet, the heating of the aluminum powder Mₚ₁ and the reduction reaction of the tetrachlorosilane gas G1 can be conducted in a short period of time of the magnitude of msec, and the productivity of silicon can be improved. Further, for the direct-current arc method the equipment is inexpensive, and therefore the production cost of silicon can be reduced. The “direct-current arc plasma jet” means a plasma jet to be obtained originating from a direct-current arc plasma.

The output power of the plasma P and the flow rate of the source gas G2 are so regulated as to maintain the plasma P at a temperature suitable for conducting the reduction reaction represented as the Formula (A). Further, the output power of the plasma P and the flow rate of the source gas G2 are so regulated as to maintain the aluminum powder Mₚ₁ in a molten state. By this means, the product of the reduction reaction represented as the Formula (A) can be collected easily.

Although the stoichiometric ratio of the amount by mole of the tetrachlorosilane gas G1 to the amount by mole of the aluminum powder Mₚ₁ in the reduction reaction according to the Formula (A) is 3:4, the ratio (M₁/M₂) of the amount by mole (M₁) of the tetrachlorosilane gas G1 to be supplied to the reaction field per unit time to the amount by mole (M₂) of the aluminum powder Mₚ₁ is preferably 0.75 to 20, more preferably 0.75 to 10, and further preferably 0.75 to 7.5, from the viewpoint of productivity and the like. In case the M₁/M₂ value is below 0.75, the progress of the reaction tends to be insufficient, meanwhile in case it exceeds 20, the amount of the tetrachlorosilane gas G1 not contributing to the reaction tends to increase.

The purity of aluminum constituting the aluminum powder Mₚ₁ is preferably 99.9% by mass or higher, more preferably 99.99% by mass or higher, and further preferably 99.995% by mass or higher. By using the high purity aluminum powder Mₚ₁ silicon with high purity can be obtained, The “purity of aluminum” means the value obtained by deducting the total contents of Fe, Cu, Ga, Ti, Ni, Na, Mg and Zn (% by mass) out of elements measured by glow-discharge mass spectrometry of a source material aluminum from 100% by mass.

Since it is difficult to remove phosphorus in a step of purifying silicon (directional solidification method), the content of phosphorus in the aluminum powder Mₚ₁ is preferably 0.5 ppm or less, more preferably 0.3 ppm or less, and especially preferably 0.1 ppm or less. From the same reason as for phosphorus, the content of boron in the aluminum powder Mₚ₁ is preferably 5 ppm or less, more preferably 1 ppm or less, and especially preferably 0.3 ppm or less.

There is possibility that impurities contained in the tetrachlorosilane gas G1 to be used for the reaction would be transferred into the produced silicon. Consequently, from the viewpoint of obtaining high purity silicon, the purity of the tetrachlorosilane gas G1 is preferably 99.99% by mass or higher, more preferably 99.999% by mass or higher, further preferably 99.9999% by mass or higher, and especially preferably 99.99999% by mass or higher. The content of each of P and B in the tetrachlorosilane gas G1 is preferably 0.5 ppm or less, more preferably 0.3 ppm or less, and especially preferably 0.1 ppm or less.

Around the reactor 3 is provided a heater 13 so as to adjust the temperature of the reaction field (inside the reactor 3). There is no particular restriction on a heating method of the reaction field, and examples of an applicable method include a direct method, such as using high frequency heating, resistance heating, and lamp heating, as well as a method using a fluid such as gas, which is temperature-adjusted in advance. The temperature of the reaction field is usually adjusted preferably to from 300 to 1200° C., and more preferably to from 500 to 1000° C. The pressure of the reaction field is usually adjusted to 1 atm or higher. This can make the silicon produced in the reactor vaporize easily, and promote the reduction reaction according to the above-described (A) to proceed. The aluminum chloride formed during the reduction reaction according to the above-described (A) has sublimating nature, and solidifies at 180° C. or lower. It is therefore preferable to keep the inside wall of the reactor 3 at 180° C. or higher to prevent deposition of aluminum chloride on the inside wall of the reactor 3.

It is preferable to keep the oxygen concentration in the reaction field prior to the initiation of the reaction as low as possible from the viewpoint of suppressing sufficiently the formation of an oxide. Specifically, the oxygen concentration in the reaction field prior to the initiation of the reaction is preferably 1% by volume or less, more preferably 0.1% by volume or less, further preferably 100 ppm by volume or less, and especially preferably 10 ppm by volume or less. It is also possible, by feeding the heated aluminum powder Mₚ₂ into the reactor 3 for a prescribed period of time, to have the heated aluminum powder Mₚ₂ adsorb the oxygen in the reaction field to decrease the oxygen concentration in the reaction field.

The dew point in the reaction field prior to the initiation of the reaction is preferably −20° C. or lower, more preferably −40° C. or lower, and further preferably −70° C. or lower.

It is also preferable to keep the oxygen concentration in the reaction field during the reaction as low as possible from the viewpoint of suppressing sufficiently the formation of an oxide. Specifically, the oxygen concentration in the reaction field during the reaction is preferably 1% by volume or less, more preferably 0.1% by volume or less, further preferably 100 ppm by volume or less, and especially preferably 10 ppm by volume or less.

The silicon collector 3b situated beneath the cylindrical part 3a is so configured that the inner diameter decreases continuously downward, and at the lower end thereof a silicon outlet 3c for discharging silicon is provided. Approximately at the vertical midpoint of the silicon collector 3b is provided a gas outlet 3d for discharging aluminum chloride (gas) formed by the reaction, unreacted tetrachlorosilane (gas), and a fine particle of silicon.

The silicon collector 3b functions as the first stage solid-gas separator. More specifically, around the silicon collector 3b is provided a heater (not illustrated), by which the internal temperature of the silicon collector 3b can be adjusted, and thus by maintaining the internal temperature of the silicon collector 3b at a temperature, at which an aluminum chloride (sublimation point: 180° C.) does not deposit, silicon and gases can be separated and deposition of aluminum chloride on the internal wall of the silicon collector 3b can be prevented. Specifically it is preferable to adjust the internal temperature of the silicon collector 3b to 200° C. or higher. In case the internal temperature of the silicon collector 3b is brought to lower than 200° C., aluminum chloride deposits in the silicon collector 3b and tends to easily contaminate silicon.

The production equipment 10 is further provided with solid-gas separators 5 and 8, and the gas discharged from the gas outlet 3d is supplied to the solid-gas separator 5. The solid-gas separator 5 functions as the second stage solid-gas separator. The solid-gas separator 5 is one for which the silicon existing in the gas discharged from the gas outlet 3d is isolated. The internal temperature of the solid-gas separator 5 is preferably also adjusted to 200° C. or higher. Examples of a suitable solid-gas separator 5 include a heat insulated cyclone solid-gas separator.

The gas discharged from the solid-gas separator 5 is supplied to the solid-gas separator 8. The solid-gas separator 8 functions as the third stage solid-gas separator. The solid-gas separator 8 is one for which aluminum chloride contained in the gas from the solid-gas separator 5 is removed. The temperature in the solid-gas separator 8 is maintained at a temperature, at which aluminum chloride deposits but tetrachlorosilane (boiling point: 57° C.) does not condense, so as to remove the deposited AlCl₃ (solid). Specifically, the temperature inside the solid-gas separator 8 is maintained preferably at 60 to 170° C., (more preferably 70 to 100° C.). In case the temperature inside the solid-gas separator 8 is brought to lower than 60° C., SiCl₄ condenses in the solid-gas separator 8 and the amount of the recycled tetrachlorosilane gas tends to be insufficient. On the contrary, in case the temperature inside the solid-gas separator 8 is brought to higher than 170° C., the deposition of aluminum chloride tends to be insufficient and the content of aluminum chloride in the recycled tetrachlorosilane gas tends to be high.

The solid-gas separator 8 is provided inside preferably with a baffle plate (not illustrated). By installing the baffle plate inside, the internal surface area of the solid-gas separator 8 is increased so that aluminum chloride deposits efficiently and the content of aluminum chloride in the gas can be decreased sufficiently. The internal surface area of the solid-gas separator 8 is preferably 5 or more times as large as the equipment surface area of the solid-gas separator 8.

The gas which is subjected to the removal treatment of aluminum chloride in the solid-gas separator 8 is discharged through a line L3 from the solid-gas separator 8. In case unreacted tetrachlorosilane gas and inert gas coexist in the gas, the inert gas can be separated and purified according to need for recovering the tetrachlorosilane gas. The tetrachlorosilane gas can be recycled. Further, the separated inert gas can also be recycled.

As described above, the production equipment 10 according to the present embodiment is provided with a silicon collector 3b as the first stage solid-gas separator, the solid-gas separator 5 as the second stage solid-gas separator, and further the solid-gas separator 8 as the third stage solid-gas separator. By adopting such constitution, unreacted tetrachlorosilane gas can be recovered efficiently and recycled. It can be recycled as, for example, the tetrachlorosilane gas G1 to be supplied to the reactor 3. In this connection, there is no particular restriction on the number of the stages of the solid-gas separators, and for example, the silicon collector 3b can be connected with the solid-gas separator 8 without using the solid-gas separator 5, or more than 4 stages of the solid-gas separators can be provided. Alternatively, the solid-gas separator 5 can be connected not with the gas outlet 3d but with the silicon outlet 3c.

According to the present embodiment, the aluminum powder Mₚ₁ whose boiling point is higher than Zn is used as a reducing agent for the tetrachlorosilane gas G1. Consequently, when the aluminum powder Mₚ₁ is heated in the plasma P, the aluminum powder Mₚ₁, different from the case of Zn, does not vaporizes and exists as a solid or a liquid droplet. In case the solid aluminum powder Mₚ₁ or the aluminum powder Mₚ₁ in the form of liquid droplets are reacted with the tetrachlorosilane gas G1, the produced silicon grows through the solid phase or through the liquid phase. Therefore according to the present embodiment, the time required for the produced silicon to grow into a silicon particle whose size is applicable to a solar cell can be shortened, compared with the case in which silicon produced by reduction with Zn grows through the vapor phase.

According to the present embodiment, unlike vaporized Zn, the solid aluminum powder Mₚ₁ or the aluminum powder Mₚ₁ in the form of liquid droplets does not diffuse excessively into the reaction field. According to the present embodiment where the aluminum powder Mₚ₁ is used as the reducing agent, the concentration of the reducing agent in the reaction field can be high and the contact frequency between the reducing agent and the halogenated silane can become high compared to the case where Zn is used as the reducing agent, and the reaction velocity and the reaction rate of the reducing agent with the halogenated silane are therefore improved.

Since the aluminum powder Mₚ₁, namely a powdery reducing agent, is heated in the plasma P according to the present embodiment, the reducing agent can be heated up and activated in a short period of time, and thereby the reaction velocity and the reaction rate of the reducing agent with the halogenated silane can be enhanced. Since the aluminum powder Mₚ₁ can be heated by the same technology as plasma spraying, which has been already established to practical use, it can be favorably adopted industrially without difficulty.

For the above-described reasons, according to the present embodiment, the productivity of silicon can be improved compared to the case using Zn as the reducing agent.

According to the present embodiment, since the aluminum powder Mₚ₁ whose valency is larger than monovalent Na is used as the reducing agent for the tetrachlorosilane gas G1, the amount by mole of a reducing agent (metal powder) required for reducing 1 mole of the tetrachlorosilane gas G1 in the reduction reaction of the tetrachlorosilane gas G1 can be decreased to ⅓ of the case using Na. Consequently, according to the present embodiment, compared to the case using Na as a reducing agent, the amount of the reducing agent required for producing silicon can be reduced and the production cost of silicon can be reduced.

According to the present embodiment, the reaction field of the reduction reaction represented by the Formula (A) is confined to the vicinity of the plasma P, it is therefore difficult for impurities originated from the reactor 3 to be involved in the reduction reaction, and high purity silicon can be synthesized.

Although favorable embodiments according to the present invention are described above in detail, the present invention is not limited thereto.

For example, the tetrachlorosilane gas G1 can be supplied to the plasma P in the heating step. This can make the heated aluminum powder and the tetrachlorosilane gas G1 be further certainly brought into contact with each other and be reacted with each other in the high temperature reaction field, and thereby the reaction velocity and the reaction rate of the aluminum powder with the tetrachlorosilane gas G1 can be enhanced.

To further certainly make the heated aluminum powder Mₚ₂ and the tetrachlorosilane gas G1 be brought into contact with each other, the tip of the SiCl₄ nozzle 4 for the production equipment 10 can be placed under the plasma generator 20 (downstream of the plasma jet).

Although according to the aforementioned embodiment an example using aluminum as the metal powder for the reducing agent is presented, the metal powder is not limited thereto, and can be singly magnesium or calcium, or can be an alloy of two or more members selected from the group consisting of magnesium, calcium and aluminum in an appropriate combination. The metal powder is preferably Mg or Al, and more preferably Al, since they are produced industrially in a large scale, easily available, and low in cost.

Although according to the aforementioned embodiment an example using tetrachlorosilane as the halogenated silane is presented, without being limited thereto, any of halogenated silanes expressed by the following Formula (1) other than tetrachlorosilane can be used singly, nr two nr more of the halogenated silanes expressed by the following Formula (1) can be used in an appropriate combination:

SiHₙX₄₋ₙ (1)

wherein n is an integer of 0 to 3; X represents an atom selected from the group consisting of F, Cl, Br and I. In case n is 0 to 2, X can be the same or different mutually.

From viewpoints of handling easiness, cost and availability, the halogenated silane is preferably SiHCl₃ or SiCl₄, and most preferably SiCl₄.

Corrosion of the reactor 3 by a reducing agent, a corrosive tetrachlorosilane gas G1, or aluminum chloride can be suppressed by maintaining the temperature of the reactor 3 at about 200° C. with water cooling, air cooling or the like.

### EXAMPLES

The present invention will be described in more detail by way of examples, provided that the present invention be not limited thereto.

### Example 1

In Example 1, silicon was produced using a production equipment almost same as FIG. 1. The production of silicon according to Example 1 will be described in reference to the production equipment 10 in FIG. 1.

As the production equipment 10 for silicon used in Example 1 was used such equipment provided with, as a plasma generator 20, a direct-current plasma spraying apparatus having a water-cooling function, and as a reactor 3, a hermetic quartz tube chamber, whose internal temperature, pressure, and atmospheric composition could be regulated.

The plasma generator 20 generated a direct-current arc plasma P (plasma jet) at an input current of 300 A. Argon gas was used as the source gas G2 for the direct-current arc plasma P. The flow rate of the source gas G2 to be supplied to the direct-current arc plasma P was set at 15 SLM (standard liter per min). Further, as a sheath gas, 5 SLM of argon gas was fed through the gap between a plasma torch and a quartz tube which were mounted on the plasma generator 20. In Example 1, a direct-current arc plasma P was generated according to normal spray conditions, under which the temperature at the center of the direct-current arc plasma P was about 8000 to 30000° C.

As the metal powder was used an aluminum powder Mₚ₁ having a particle size of 25 to 45 μm.

Firstly, in the heating step, a mixture of aluminum powder Mₚ₁ and argon gas as a carrier gas was supplied through the aluminum powder supply pipe 21 into the direct-current arc plasma P (near the outlet of the plasma torch nozzle) to melt the aluminum powder Mₚ₁ completely. The heated aluminum powder Mₚ₂ (molten droplet of aluminum) was supplied by the plasma jet toward the reactor 3 (downstream of the plasma jet).

In the heating step the flow rate of argon gas as the carrier gas was set at 2 SLM, and the supply rate of the aluminum powder Mₚ₁ to the direct-current arc plasma P was set at 0.9 g/min.

Next in the reducing step, the tetrachlorosilane gas G1 together with argon gas as the carrier gas were supplied using the SiCl₄ nozzle 4 with the inner diameter of 4.4 mm into the reactor 3 (to the position 120 mm below the plasma torch nozzle) to react the tetrachlorosilane gas G1 and the heated aluminum powder Mₚ₂ (molten droplet of aluminum) to obtain powder as the product.

In the reducing step the supply flow rate of the argon gas as the carrier gas of the tetrachlorosilane gas G1 was set at 0.825 SLM, and the supply flow rate of the tetrachlorosilane gas G1 was set at 0.274 SLM (equivalent to the saturated vapor pressure).

The product powder was collected 380 mm below the plasma torch nozzle. The light micrograph of the obtained product powder was shown in FIG. 2.

A fluorescent X-ray analysis was conducted on the product powder. As a result, it was confirmed that among the elements contained in the product powder, the highest content element was silicon, the next highest content element after silicon was aluminum, and the next highest content element after aluminum was chlorine. The content of silicon with respect to the total product powder was 50.7% by weight, the content of aluminum was 35.6% by weight, and the content of chlorine was 8.4% by weight.

The product powder was further analyzed by powder X-ray diffractometry. The X-ray diffraction pattern of the product powder is shown in FIG. 3. As shown in FIG. 3, an X-ray peak corresponding to a silicon crystal was recognized.

From the fluorescent X-ray analysis and the powder X-ray diffractometry pattern, it was confirmed that the product powder according to Example 1 contained a particle composed of a silicon crystal.

### Referencing Example 1

As Reference Example 1, the distributions of temperature T (in K) in the plasma jet and gas linear velocity V (in m/s) of the plasma jet were calculated by a simulation. The results are shown in FIG. 4. With respect to the abscissa in FIG. 4 the origin O represents the tip of the plasma torch nozzle (the origin of the plasma jet), and the value on the abscissa represents the distance from the tip of the plasma torch nozzle.

For the simulation in Reference Example 1 was used the plasma spraying simulation software (Jets & Poudres) developed by the group of Fauchais, et al. at the University Limoges in France. The calculation conditions of the simulation were as follows:

the diameter of the torch nozzle, 6 (mm); the pressure of the atmosphere, atmospheric pressure; the source gas for the plasma, Ar gas; the gas flow rate of the Ar gas, 30 (L/min); the input power for the plasma, 10 (kW); and the power conversion efficiency, 50%.

Next, under similar conditions as the above-described simulation for the case where an Al particle whose size is 50 μm is supplied to the tip of the plasma torch nozzle, the changes over time of the temperature T (in K) and the flight distance X (in mm) of the Al particle were calculated. The results are shown in FIG. 5. In FIG. 5, the origin 0 of the abscissa represents a time point when the Al particle was supplied to the tip of the plasma torch nozzle.

As shown in FIG. 5 it has been confirmed that the temperature of the Al particle supplied to the plasma jet reaches approximately 1500° C. in about 1 msec.

### INDUSTRIAL APPLICABILITY

As described above, according to the present invention, in the production of silicon, the productivity of silicon can be improved and simultaneously the production cost of silicon can be reduced.

### REFERENCE SIGNS LIST

3; reactor: 3a; cylindrical part: 3b; silicon collector: 3c; particle outlet: 3d; gas outlet: 4; SiCl₄ nozzle: 5,8; solid-gas separator: 10; production equipment: 13; heater: 20; plasma generator: 21; aluminum powder supply pipe: G1; tetrachlorosilane gas: G2; source gas for plasma: L1; supply pipe of tetrachlorosilane: L3; line (piping): Mₚ₁; metal powder (aluminum powder): Mₚ₂; metal powder (aluminum powder) heated in plasma: P; plasma: and X; central axis of reactor.

1. A method for producing silicon, the method comprising a heating step of heating a metal powder comprising at least one member selected from the group consisting of Mg, Ca and Al in a plasma and/or a plasma jet; and
a reducing step of reducing a halogenated silane by the metal powder heated in the plasma and/or the plasma jet to obtain silicon.

2. The method for producing silicon according to claim 1, wherein in the heating step a mixture of a source gas of the plasma and/or a source gas of the plasma jet and the metal powder is heated in the plasma and/or the plasma jet.

3. The method for producing silicon according to claim 1, wherein in the heating step the metal powder is supplied into the plasma and/or the plasma jet and the metal powder is heated in the plasma and/or the plasma jet; and
in the reducing step the metal powder heated in the plasma and/or the plasma jet is brought into contact with the halogenated silane to reduce the halogenated silane to obtain the silicon.

4. The method for producing silicon according to claim 1, wherein in the heating step the metal powder is heated in the plasma and/or the plasma jet to be liquefied.

5. The method for producing silicon according to claim 1, wherein in the heating step the halogenated silane is supplied into the plasma and/or the plasma jet.

6. The method for producing silicon according to claim 1, wherein a source gas of the plasma and/or a source gas of the plasma jet is at least one member selected from the group consisting of H₂, He and Ar.

7. The method for producing silicon according to claim 1, wherein the metal powder comprises Al.

8. The method for producing silicon according to claim 1, wherein the halogenated silane is tetrachlorosilane.

9. The method for producing silicon according to claim 1, wherein the plasma is a thermal plasma, and the plasma jet is a thermal plasma jet.

10. The method for producing silicon according to claim 9, wherein the thermal plasma is a direct-current arc plasma and the thermal plasma jet is a direct-current arc plasma jet.
